(19) United States
(12) Patent Application Publication
(10) Pub. No.: US 2011/0015285 A1
(43) Pub. Date: Jan. 20, 2011

(54) FOAMABLE COPOLYMERS BASED ON RENEWABLE RAW MATERIALS

(75) Inventors: Francesca Aulenta, Mannheim (DE); Markus Braun, Heidelberg (DE); Arnold Schneller, Frankenthal (DE); Rainer Dyllick-Brenzinger, Neustadt (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/863,734

(22) PCT Filed: Jan. 21, 2009
(86) PCT No.: PCT/EP2009/050609

§ 371 Date: Sep. 3, 2010

(30) Foreign Application Priority Data
Jan. 23, 2008 (EP) 08150529.9

(51) Int. Cl. C08J 9/00; C08F 8/32; C08F 8/30; C08L 33/06; C08K 3/34

(52) U.S. Cl. 521/50.5; 525/55; 525/380; 525/374; 524/560; 524/451; 521/149

(57) ABSTRACT

The invention relates to a process for the production of foamable copolymers, to foamable copolymers and to foamable polymer structures based on itaconic acid, mesaconic acid, fumaric acid, maleic acid, aconitic acid, and glutaconic acid.

The invention relates to a process for the production of foamable copolymers, and to the foamable copolymers themselves, and to foamable polymer structures.

Processes for the foaming of thermoplastics are known, as also are foamable thermoplastic compositions suitable for use in such processes. The foaming processes for obtaining a foamed structure, typically comprise the melting of the thermoplastic resin, the introduction of a gas (blowing agent) or of a gas source (e.g. chemical blowing agent) into the resin prior to or after melting, and then extrusion of the molten thermoplastic through a die. Expandable polystyrene products use physical blowing agents, such as pentane, which can diffuse out of the polymer matrix during storage, a possible result being production of an ignitable or explosive atmosphere. The use of non-combustible, polymer-bound, and polymerizable blowing agents avoids these risks and provides considerable advantages in terms of risk-reduction and economics.

Spontaneous liberation of the blowing agent (for example of CO₂) is an established method for the production of foams based on polyurethane, on polyureas, on polycarbonates, on organopolysiloxanes, on polyesters, on polyamides, on polyimides and on polyacetal foams and on foamable polyphenol-based resins. A wide variety of publications describe the decarboxylation of unstable carboxylic acids or unstable anhydrides, these having been bound within the polymer matrix.

EP 0 850 981 A1 describes a process for the production of water-absorbent, foam-type polymers, the foam of which is formed via decarboxylation of organic compounds, such as citric acid, comprised in a perfluoro polymer.

B. E. Tate in [B. E. Tate, Advanced Polymer Science, 1967, 5, 214 to 232], teaches that polymers and copolymers composed of itaconic acid and acrylic acid or itaconic acid, styrene and vinyl acetate decarboxylate slowly under mild temperature conditions at about 100° C.

JP 419192 describes the use of copolymerizable itaconic acid as blowing agent for the production of polyacrylamide- and polyacrylic-acid-based foams.

It is an object to provide foamable copolymers which do not have the disadvantages known from the prior art. Another object is to provide a process for the production of foamable copolymers and of foamable polymer structures.

This object is achieved via foamable copolymers obtainable from the reaction of
(a) at least one reaction mixture comprising at least one copolymer obtained via free-radical copolymerization of one or more monoethylenically unsaturated monomeric compound(s) or their anhydride(s) (monomer(s) A1) with one or more compound(s) selected from the group of itaconic acid, mesaconic acid, fumaric acid, maleic acid, aconitic acid, glutaconic acid and their salts, esters and anhydrides (monomer(s) A2),
   with
(b) one or more crosslinking agents.

In the course of studies of foamable copolymers, it was specifically and surprisingly found that, when the inventive foamable copolymers were compared with Styropor, the material of these copolymers has almost unlimited storability, and can be foamed as required.

Monomers A1 that can be used are in principle any of the ethylenically unsaturated monomers capable of free-radical copolymerization with the monomers A2, e.g. ethylenically unsaturated, in particular α,β-monoethylenically unsaturated, C3-C6, preferably C3 or C4, mono- or dicarboxylic acids, and their water-soluble salts, in particular their alkali metal salts or ammonium salts, e.g. acrylic acid, methacrylic acid, ethylacrylic acid, allylacetic acid, crotonic acid, vinylacetic acid, fumaric acid, maleic acid, maleic anhydride, methylmaleic acid and the ammonium, sodium or potassium salts of the abovementioned acids.

Examples of other monomers A1 that can be used alongside these are vinylaromatic monomers, such as styrene, α-methylstyrene, o-chlorostyrene or vinyltoluene, vinyl halides, such as vinyl chloride or vinylidene chloride, esters composed of vinyl alcohol and of monocarboxylic acids having from 1 to 18 carbon atoms, e.g. vinyl acetate, vinyl propionate, vinyl n-butyrate, vinyl laurate and vinyl stearate, esters composed of α,β-monoethylenically unsaturated mono- and dicarboxylic acids, preferably having from 3 to 6 carbon atoms, e.g. in particular acrylic acid, methacrylic acid, maleic acid, fumaric acid, and itaconic acid, with alkanols generally having from 1 to 12, preferably from 1 to 8, and in particular from 1 to 4, carbon atoms, e.g. particularly methyl, ethyl, n-butyl, isobutyl, pentyl, hexyl, heptyl, octyl, nonyl, decyl and 2-ethylhexyl acrylates and the corresponding methacrylates, dimethyl or di-n-butyl fumarates and the corresponding maleates, nitriles of α,β-monoethylenically unsaturated carboxylic acids, e.g. acrylonitrile, methacrylonitrile, fumaronitrile, maleonitrile, and C4-8-conjugated dienes, such as 1,3-butadiene (butadiene) and isoprene. Other monomers A1 can be used are those ethylenically unsaturated monomers which have at least one sulfonic acid group and/or its corresponding anion and/or have at least one amino, amido, ureido, or N-heterocyclic group and/or its nitrogen-protonated or -alkylated ammonium derivatives. Examples that may be mentioned are acrylamide and methacrylamide, and also vinylsulfonic acid, 2-acrylamido-2-methylpropanesulfonic acid, styrenesulfonic acid and water-soluble salts thereof, and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylamino-propyl)methacrylamide, and 2-(1-imidazolin-2-onyl)ethyl methacrylate, glycidyl acrylate.

Monoethylenically unsaturated monomeric compounds used or, if appropriate, their anhydrides or esters are preferably styrene, α-methylstyrene, o-chlorostyrene, vinyl chloride, vinylidene chloride, vinyl acetate, vinyl propionate, vinyl n-butyrate, vinyl laurate, vinyl stearate, itaconic acid, acrylonitrile, methacrylonitrile, fumaronitrile, maleonitrile, 1,3-butadiene (butadiene), isoprene, acrylamide and methacrylamide, vinylsulfonic acid, acrylic acid, methacrylic acid, maleic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearylic acid, citraconic acid, aconitic acid, fumaric acid, tricarboxyethylene anhydride and maleic anhydride, and particular preference is given here to acrylic acid and methacrylic acid, styrene, and methyl (meth)acrylate.

Monomers A2 that can be used are itaconic acid, mesaconic acid, fumaric acid, maleic acid, aconitic acid, and glutaconic acid, and their salts, anhydrides and/or alkyl esters. Alkyl esters here are intended as meaning not only the corresponding monoalkyl esters, but also the di- or trialkyl esters, in particular the corresponding C₁-C₂₀-alkyl esters, preferably the mono- or dimethyl or -ethyl esters. The invention is, of course, also intended to comprise the corresponding salts of the abovementioned acids, e.g. the alkali metal salts, alkaline earth metal salts, or the ammonium salts, in particular the corresponding sodium, potassium or ammonium salts. According to one preferred embodiment of the invention, itaconic acid or itaconic anhydride is used, but particular preference is given here to itaconic acid.

The reaction mixture (a) comprises from 0.1 to 70% by weight, preferably from 1 to 50% by weight and with particular preference from 1 to 25% by weight, of at least one monomer A2 in copolymerized form.

According to one preferred embodiment, the ratio of the monoethylenically unsaturated compound (monomers A1) to the one or more compounds selected from the group of itaconic acid, mesaconic acid, glutaconic acid, fumaric acid, maleic acid, and aconitic acid and their salts, esters and anhydrides (monomers A2) is in the range from 1 bis 50% by weight of at least one monomer A2, and from 50 to 99% by weight of at least one monomer A1 and with particular advantage from 1 to 25% by weight of at least one monomer A2 and from 75 to 99% by weight of at least one monomer A1. The percentage by weight data here are always based on the entire copolymer.

The K value of the copolymer comprised in the reaction mixture (a), determined by the Fikentscher method, see page 15 (1% strength in deionized water), is typically from 19 to 80, preferably from 30 to 50, particularly preferably from 32 to 38. The number-average molecular mass of the copolymers comprised in the reaction mixture (a) is from 15 000 to 5 000 000 g/mol, preferably from 150 000 to 600 000 g/mol, particularly preferably from 300 000 to 400 000 g/mol, with particular preference from 300 000 to 400 000 g/mol.

According to the invention, preferred crosslinking agents of feature (b) are compounds which have at least two functional groups which can react with the free functional groups of the copolymers comprised in the reaction mixture (a), in a condensation reaction or in an addition reaction.

Examples that may be mentioned as crosslinking agents of feature (b) are polyols, e.g. ethylene glycol, polyethylene glycol such as diethylene glycol, triethylene glycol and tetraethylene glycol, propylene glycol, polypropylene glycol, such as dipropylene glycol, tripropylene glycol or tetrapropylene glycol, 1,3-butanediol, 1,4-butanediol, 1,5-pentanediol, 2,4-pentanediol, 1,6-hexanediol, 2,5-hexanediol, glycerol, polyglycerol, trimethylolpropane, polyoxypropylene, oxyethylene-oxypropylene block copolymers, sorbitan fatty acid esters, polyoxyethylenesorbitan fatty acid esters, pentaerythritol, polyvinyl alcohol, and sorbitol, aminoalcohols, e.g. ethanolamine, diethanolamine, triethanolamine or propanolamine, polyamine compounds, e.g. ethylenediamine, diethylenetetramine, triethylenetetramine, tetraethylenepentamine or pentaethylenehexamine, N,N,N,N-tetrakis(2-hydroxyethyl)ethylenediamine (THEED), N,N,N,N-tetrakis(2-hydroxyethyl)adipamide (THEAA), triisopropanolamine (TRIPA), polyglycidic ether compounds, such as ethylene glycol diglycidyl ether, polyethylene glycol diglycidyl ether, glycerol polyglycidyl ether, pentaerythritol polyglycidyl ether, propylene glycol diglycidyl ether, polypropylene glycol diglycidyl ether, neopentyl glycol diglycidyl ether, hexanediol glycidyl ether, trimethylolpropanol glycidyl ether, sorbitol polyglycidyl ether, phthalic acid diglycidyl ether, adipic acid diglycidyl ether, glycidol, polyisocyanates, preferably diisocyanates, such as toluene 2,4-diisocyanate and hexamethylene diisocyanate, polyaziridine compounds, such as 2,2-bishydroxymethylbutanol tris[3-(1-aziridinyl)propionate], 1,6-hexamethylenediethyleneurea and diphenylmethanebis-4,4′-N,N′-diethyleneurea, halogen peroxides such as epichlorohydrin and epibromohydrin and α-methylepichlorohydrin, alkylene carbonates such as 1,3-dioxolan-2-one ethylene carbonate, 4-methyl-1,3-dioxolan-2-one(propylene carbonate), polyquaternary amines such as condensates of dimethylamines and epichlorohydrin, di-, tri- and polyamines and polyol compounds having at least two hydroxy groups.

The polyol compound, hereinafter termed polyol, can in principle be a compound whose molar mass is ≦1000 g/mol or a polymeric compound whose molar mass is >1000 g/mol. Examples that may be mentioned of compounds having at least 2 hydroxy groups are polyvinyl alcohol, partially-hydrolyzed polyvinyl acetate, homo- or copolymers of hydroxyalkyl acrylates or of hydroxyalkyl methacrylates, e.g. hydroxyethyl acrylate and the corresponding methacrylate or hydroxypropyl acrylate and the corresponding methacrylate. Examples of other polymeric polyols are found inter alia in WO 97/45461, page 3, line 3 to page 14, line 33.

Any of the organic compounds which have at least 2 hydroxy groups and whose molar mass is ≦1000 g/mol can be used as polyol whose molar mass is ≦1000 g/mol. Examples that may be mentioned are ethylene glycol, propylene 1,2-glycol, glycerol, 1,2- or 1,4-butanediol, pentaerythritol, trimethylolpropane, sorbitol, sucrose, glucose, 1,2-, 1,3- or 1,4-dihydroxybenzene, 1,2,3-trihydroxybenzene, 1,2-, 1,3- or 1,4-dihydroxycyclohexane, and preferably alkanolamines, e.g. compounds of the general formula I

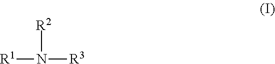

in which R² is a hydrogen atom, a C₁-C₁₀-alkyl group, or a C₂-C₁₀-hydroxyalkyl group, and R² and R³ are a C₂-C₁₀-hydroxyalkyl group.

It is particularly preferable that R² and R³, independently of one another, are a C₂-C₅-hydroxyalkyl group and R¹ is a hydrogen atom, a C₁-C₅-alkyl group, or a C₂-C₅-hydroxyalkyl group.

Particular compounds of the formula I that may be mentioned are diethanolamine, triethanolamine, diisopropanolamine, triisopropanolamine, methyldiethanolamine, butyldiethanolamine and/or methyldiisopropanolamine.

Examples of other polyols whose molar mass is ≦1000 g/mol are likewise found in WO 97/45461, page 3, line 3 to page 14, line 33.

The polyol is preferably selected from the group comprising diethanolamine, triethanolamine, diisopropanolamine, triisopropanolamine, methyldiethanolamine, butyldiethanolamine and/or methyldiisopropanolamine, particular preference being given here to triethanolamine.

Particularly preferred crosslinking agents are triethanolamine, N,N,N,N-tetrakis(2-hydroxyethyl)ethylenediamine, and triisopropanolamine.

The reaction mixture (a) and the crosslinking agent of feature (b) are generally and preferably used in a quantitative ratio with respect to one another such that the ratio by weight of reaction mixture to crosslinking agent is from 1:10 to 100:1, advantageously from 1:5 to 50:1 and particularly advantageously from 1:1 to 20:1.

It is preferable that the amount used of the crosslinking agent(s) (b) is in the range from 5 to 65% by weight, preferably in the range from 20 to 60% by weight, particularly preferably in the range from 20 to 30% by weight, based in each case on the entire copolymer.

The inventive foamable copolymers are generally obtainable via reaction of at least one component (a) and of at least one component (b). However, other components can moreover be used during the reaction of components (a) and (b). By way of example, it is advantageous to carry out the reaction of components (a) and (b) in the presence of a nucleating agent. Suitable selection of the nucleating agent can vary the structure of the foams, pore sizes and pore distribution, as a function of the intended use of the respective foam. Nucleating agents preferably used are talc (magnesium silicate), magnesium carbonate, calcium carbonate, huntite, hydromagnesite and KMgAl silicates or a mixture of these. The nucleating agent is particularly preferably talc.

The amount used of the other components, such as the nucleating agents, in the reaction mixture comprising (a) and (b) is in the range from 0.1 to 5% by weight, preferably in the range from 0.5 to 2% by weight, particularly preferably in the range from 1 to 1.5% by weight, based on the entire weight of the reactants.

An advantageous feature of the inventive foamable copolymers is that, because of the incompleteness of the crosslinking reaction, some of the carboxylic acid groups remain in free form in the polymer, thus giving the inventive copolymers hydrophilic properties. The hydrophilic properties of the copolymers can be regulated via variation of the itaconic acid content, and the nature and concentration of the crosslinking agent and/or via admixture of other polymers. The other polymers here are polystyrene, polyester, thermoplastics, polyamides, and mixtures of a plurality of the above-mentioned polymers.

During the foaming of the inventive foamable copolymer, the potential blowing agent bound within the polymer decomposes via decarboxylation of the free carboxy groups of the itaconic acid, mesaconic acid, fumaric acid, maleic acid, aconitic acid or glutaronic acid. The decarboxylation reaction liberates an amount of CO₂ sufficient to bring about the foaming of the inventive copolymers. The inventive copolymers therefore provide their own blowing agent and to this extent are “self-foaming”. A feature of the foams or foam-type polymer structures obtained via foaming of the inventive copolymers is a density in the range from 40 to 300 g/l, preferably in the range from 50 to 200 g/l. The thermal conductivity of the resultant foams or foam-type polymer structures is generally in the range of from 0.04 W/mK to 0.09 W/mK. Foams or foam-type polymer structures whose thermal conductivity is 0.0467 W/mK (use of THEED as crosslinking agent), 0.079 W/mK (use of TEA as crosslinking agent), and 0.0575 W/mK (use of TiPA as crosslinking agent) were produced in the context of the examples.

The invention further provides a process for the production of the inventive foamable copolymers comprising the steps of:
(i) preparation of at least one reaction mixture (a) via free-radical copolymerization of one or more monoethylenically unsaturated monomeric compound(s) (monomer(s) A1) with one or more compound(s) selected from the group consisting of itaconic acid, mesaconic acid, glutaconic acid, fumaric acid, maleic acid and aconitic acid and their salts, esters and anhydrides (monomer(s) A2), and
(ii) reaction of at least one of the copolymers obtained in step (i) with one or more crosslinking agents.

The preparation of the reaction mixture in step (i) can take place by various free-radical polymerization processes known to the person skilled in the art. Preference is given to homogeneous-phase free-radical polymerization, in particular, in aqueous solution in the form of what is known as gel polymerization, or polymerization in an organic solvent. Other possibilities are precipitation polymerization from organic solvents, for example from alcohols, or suspension, emulsion or microemulsion polymerization. Other adjuvants, such as chain regulators, such as mercaptoethanol, can be used in the polymerization reaction as well as the polymerization initiators.

The free-radical polymerization in step (i) usually takes place in the presence of compounds which are known as initiators and which form free radicals.

The amounts used of these compounds which form free radicals are usually up to 30% by weight, preferably from 0.05 to 15% by weight, in particular from 0.2 to 8% by weight, based on the starting materials to be polymerized. In the case of initiators composed of a plurality of constituents (initiator systems e.g. redox initiator systems) the weight data above are based on the entirety of the components.

Examples of suitable initiators are organic peroxides and hydroperoxides, and also peroxide sulfates, percarbonates, peroxide esters, hydrogen peroxide, and azo compounds. Examples of these initiators are hydrogen peroxide, dicyclohexyl peroxide dicarbonate, diacetyl peroxide, di-tert-butyl peroxide, diamyl peroxide, dioctanoyl peroxide, didecanoyl peroxide, dilauroyl peroxide, dibenzoyl peroxide, bis(o-toluoyl) peroxide, succinyl peroxide, methyl ethyl ketone peroxide, di-tert-butyl hydroperoxide, acetylacetone peroxide, butyl peracetate, tert-butyl permaleate, tert-butyl isobutyrate, tert-butyl perpivalate, tert-butyl peroctoate, tert-butyl perneodecanoate, tert-butyl perbenzoate, tert-butyl hydroperoxide, cumene hydroperoxide, tert-butyl perneodecanoate, tert-amyl perpivalate, tert-butyl perpivalate, tert-butoxy-2-ethylhexanoate and diisopropyl peroxydicarbamate; and lithium peroxodisulfate, sodium peroxodisulfate, potassium peroxodisulfate and ammonium peroxodisulfate, the azo initiators 2,2′-azobisisobutyronitrile, 2,2′-azobis(2-methylbutyronitrile), 2,2′-azobis[2methyl-N-(2-hydroxyethyl)propionamide, 1,1′-azobis(1-cyclohexanecarbomitrile), 2,2′-azobis(2,4-dimethylvaleronitrile), 2,2′-azobis(N,N′-dimethyleneisobutyroamidine) dihydrochloride, and 2,2′-azobis(2-amidinopropane) dihydrochloride, and the redox initiator systems explained hereinafter.

Redox initiator systems comprise at least one peroxide-containing compound in combination with a redox coinitiator, for example a sulfur compound having reducing action, e.g. bisulfites, sulfites, thiosulfates, dithionites and tetrathionates of alkali metals or of ammonium compounds. Combinations of peroxodisulfates with alkali metal hydrogen sulfites or with ammonium hydrogen sulfites can therefore be used, examples being ammonium peroxodisulfate and ammonium disulfite. The amount of the peroxide-containing compounds with respect to the redox coinitiator is generally from 30:1 to 0.05:1.

The initiators can be used alone or in a mixture with one another, examples being mixtures composed of hydrogen peroxide and sodium peroxodisulfate.

The initiators can be either water-soluble or non-water-soluble, or only sparingly water-soluble. As initiators for the free-radical polymerization in an aqueous medium, it is preferable to use water-soluble initiators, i.e. initiators which are soluble in the aqueous polymerization medium at the concentration usually used for the polymerization reaction. Among these are peroxodisulfates, azo initiators having ionic groups, organic hydroperoxides having up to 6 carbon atoms, acetone hydroperoxide, methyl ethyl ketone hydroperoxide and hydrogen peroxide, and the abovementioned redox initiators.

In combination with the initiators or with the redox initiator systems, transition metal catalysts can also be used, examples being salts of iron, cobalt, nickel, copper, vanadium and manganese. Examples of suitable salts are iron(I) sulfate, cobalt(II) chloride, nickel(II) sulfate or copper(I) chloride. The concentration used, based on the monomers, of the transition metal salt with reducing action is from 0.1 ppm to 1000 ppm. Combinations of hydrogen peroxide with iron(II) salts can therefore be used, an example being from 0.5 to 30% of hydrogen peroxide and 0.1 to 500 ppm of Mohr's salt.

In combination with the abovementioned initiators it is also possible, in the free-radical copolymerization reaction in organic solvents, to make concomitant use of redox coinitiators and/or of transition metal catalysts, examples being benzoin, dimethylaniline, and ascorbic acid, and heavy-metal complexes soluble in organic solvents, examples being those of copper, cobalt, iron, manganese, nickel and chromium. The amounts usually used of redox coinitiators and, respectively, transition metal catalysts is from about 0.1 to 1000 ppm, based on the amounts used of monomers.

The free-radical copolymerization reaction can also be carried out via exposure to ultraviolet radiation, if appropriate in the presence of UV initiators. Examples of these initiators are compounds such as benzoin and benzoin ethers, α-methylbenzoin or α-phenylbenzoin. The compounds known as triplet sensitizers can also be used, examples being benzyl diketals. Examples of UV radiation sources used are not only high-energy UV lamps such as carbon-arc lamps, mercury vapor lamps or xenon lamps, but also low-UV content light sources, such as fluorescent tubes with high blue content.

In order to control the average molecular weight of the free-radical polymerization reaction in process step (i), it is often advantageous to carry out the free-radical copolymerization reaction in the presence of regulators. Regulators that can be used for this purpose are in particular compounds comprising organic SH groups, in particular water-soluble compounds comprising SH groups, e.g. 2-mercaptoethanol, 2-mercaptopropanol, 3-mercaptopropionic acid, cysteine, N-acetylcysteine, and moreover phosphorus(III) compounds or phosphorus(I) compounds, e.g. alkali metal hypophosphites or alkaline earth metal hypophosphites, an example being sodium hypophosphite, or else hydrogensulfites such as sodium hydrogensulfite. The amounts generally used of the polymerization regulators are from 0.05 to 10% by weight, in particular from 0.1 to 2% by weight, based on the monomers. Preferred regulators are the abovementioned compounds bearing SH groups, in particular water-soluble compounds bearing SH groups, e.g. 2-mercaptoethanol, 2-mercaptopropanol, 3-mercaptopropionic acid, cysteine and N-acetylcysteine. Use of an amount of from 0.05 to 2% by weight, in particular from 0.1 to 1% by weight, of these compounds, based on the monomers, has proven successful. The amounts used of the abovementioned phosphorus(III) compounds and phosphorus(I) compounds, and of the hydrogen sulfites, are usually greater, for example from 0.5 to 10% by weight and in particular from 1 to 8% by weight, based on the monomers to be polymerized. The selection of the appropriate solvent can also be used to influence average molecular weight. By way of example, polymerization in the presence of diluents having benzylic or allylic hydrogen atoms leads via chain transfer to a reduction in average molecular weight.

The free-radical copolymerization reaction in step (i) can take place by the usual polymerization processes, including solution polymerization, precipitation polymerization, suspension polymerization, or bulk polymerization. The solution polymerization method is preferred, i.e. polymerization in solvents or diluents.

Among the suitable solvents or diluents are not only aprotic solvents, e.g. aromatics, such as toluene, o-xylene, p-xylene, cumene, chlorobenzene, ethylbenzene, technical mixtures of alkylaromatics, aliphatics and cycloaliphatics, such as cyclohexane, and technical aliphatic mixtures, ketones such as acetone, cyclohexanone and methyl ethyl ketone, ethers, such as tetrahydrofuran, dioxane, diethyl ether, and tert-butyl methyl ether, and C₁-C₄-alkyl esters of aliphatic C₁-C₄ carboxylic acids, e.g. methyl acetate and ethyl acetate, and also protic solvents, such as glycols and glycol derivatives, polyalkylene glycols and their derivatives, C₁-C₄ alkanols, e.g. n-propanol, n-butanol, isopropanol, ethanol or methanol, but also water and mixtures of water with C₁-C₄ alkanols, an example being isopropanol-water mixtures. The inventive free-radical copolymerization process preferably takes place in water or in a mixture composed of water with up to 60% by weight of C₁-C₄ alkanols or of glycols, as solvent or diluent. Water is particularly preferably used as sole solvent.

The copolymerization process can moreover be carried out in the presence of surfactants. Surfactants used can be anionic, cationic, nonionic or amphoteric surfactants, or a mixture of these. Either low-molecular-weight surfactants or polymeric surfactants can be used. Examples of nonionic surfactants are adducts of alkylene oxides, in particular ethylene oxide, propylene oxide and/or butylene oxide, on to alcohols, amines, phenols, naphthols or carboxylic acids. Adducts of ethylene oxide and/or propylene oxide onto alcohols comprising at least 10 carbon atoms are advantageously used as surfactants, where the amount of ethylene oxide and/or propylene oxide in the adduct is from 3 to 200 mol per mole of alcohol. The adducts comprise the alkylene oxide units in the form of blocks or in random distribution.

Cationic surfactants are also suitable. Examples of these are the dimethyl-sulfate-quaternized reaction products of 6.5 mol of ethylene oxide with 1 mol of oleylamine, distearyldimethylammonium chloride, laurylmethylammonium chloride or cetylpyridinium bromide, and dimethyl-sulfate-quaternized triethanolamine ester of stearic acid.

The amounts of the surfactants comprised in the copolymerization composition are preferably in the range from 0.01 to 15% by weight, particularly preferably in the range from 0.1 to 5% by weight, based in each case on the weight of the composition.

Other auxiliaries that can be used in process step (i) are stabilizers, thickeners, fillers or cell nucleators or a mixture of these.

The amount preferably used of the auxiliaries in the composition used in the process step (i) is preferably in the range from 0.01 to 15% by weight, particularly preferably in the range from 0.1 to 5% by weight, based in each case on the total weight of the composition.

The free-radical copolymerization process is preferably carried out with substantial or complete exclusion of oxygen, preferably in a stream of inert gas, for example, a stream of nitrogen.

The inventive process can be carried out in the apparatuses conventionally used in polymerization processes. Among these are stirred tanks, stirred-tank cascades, autoclaves, tubular reactors and kneaders. The free-radical copolymerization reaction is by way of example, carried out in stirred tanks equipped with an anchor stirrer, blade stirrer, impeller stirrer, or multistage countercurrent pulse agitator. Apparatuses which permit direct isolation of the solid product after the polymerization reaction are particularly suitable, examples being paddle driers. The polymer suspensions obtained can be dried directly in evaporators, for example belt driers, paddle driers, spray driers, or fluidized-bed driers. However, it is also possible to remove most of the inert solvent via filtration or centrifuging and, if appropriate, to use repeated washing with fresh solvent to remove residues—if present—of initiators, monomers and protective colloids, and to delay drying of the copolymers until this has been done.

The free-radical copolymerization reaction usually takes place at temperatures in the range from 0° C. to 300° C., preferably in the range from 40 to 120° C. The polymerization time is usually in the range from 0.5 hours to 15 hours and in particular in the range from 2 to 6 hours. The pressure prevailing during the free-radical copolymerization reaction is relatively unimportant for the success of the polymerization reaction and is generally in the range of 800 mbar to 2 bar and frequently ambient pressure. If volatile solvents or volatile monomers are used, the pressure can also be higher.

The copolymers obtained in process step (i) are, in process step (ii), reacted with one or more crosslinking agent(s). The reaction takes place, if appropriate, in the presence of a solvent or diluent. Among the suitable solvents or diluents are not only aprotic solvents, e.g. aromatics, such as toluene, o-xylene, p-xylene, cumene, chlorobenzene, ethylbenzene, technical mixtures of alkylaromatics, aliphatics and cycloaliphatics, such as cyclohexane, and technical aliphatic mixtures, ketones such as acetone, cyclohexanone and methyl ethyl ketone, ethers, such as tetrahydrofuran, dioxane, diethyl ether, and tert-butyl methyl ether, and C₁-C₄-alkyl esters of aliphatic C₁-C₄ carboxylic acids, e.g. methyl acetate and ethyl acetate, and also protic solvents, such as glycols and glycol derivatives, polyalkylene glycols and their derivatives, C₁-C₄ alkanols, e.g. n-propanol, n-butanol, isopropanol, ethanol or methanol, but also water and mixtures of water with C₁-C₄ alkanols, an example being isopropanol-water mixtures. The reaction process step (ii) preferably takes place in water or in a mixture composed of water with up to 60% by weight of C₁-C₄ alkanols or of glycols, as solvent or diluent. Water is particularly preferably used as sole solvent.

The reaction in process step (ii) usually takes place at temperatures in the range from 0° C. to 100° C., preferably in the range from 20 to 80° C. The reaction time is usually in the range from 0.5 hour to 15 hours and in particular in the range from 1 to 2 hours. The pressure prevailing during the reaction is relatively unimportant for the success of the reaction and is generally in the range of 800 mbar to 2 bar and frequently ambient pressure.

Process step (ii) can, like process step (i), be carried out in the apparatuses described above and usually used for methods of polymerization. Reference is made here to comments made in connection with the free-radical copolymerization process.

The present invention also provides the production of foams from the inventive foamable copolymers.

To this end, the inventive foamable copolymers obtained in process step (ii) can be processed further in a variety of ways. They can, according to one embodiment of the invention, be directly foamed, without prior purification, in the form of polymer, to give a foam. According to another embodiment, they are spray- or freeze-dried, ground if necessary, and then foamed. As an alternative, the inventive foamable copolymers can likewise be cast in the form of polymer on a carrier to give a film and, after a number of days of drying at temperatures of about 40° C. be cast can be milled in a suitable mill to give a powder, which is then further processed to give a foam.

According to one general embodiment of the invention, the inventive copolymers are foamed at a temperature in the range from 50 to 300° C., preferably at a temperature in the range from 100 to 250° C., particularly preferably at a temperature in the range from 140 to 230° C. The duration of the foaming procedure varies as a function of the temperature. The time for which the temperature is maintained is usually in the region of 65 minutes. According to another embodiment of the invention it is possible to foam the foamable copolymers with exposure to microwave radiation. When microwave radiation is used, the inventive copolymers are generally foamed with energy input of from 360 to 800 W over a period of from 6 to 20 minutes, at room temperature.

According to another embodiment of the invention, the inventive foamable copolymers are blended with another component, prior to the foaming process. An example of another component that can be used here is polystyrene, starch, polyester, polyols, polyamides, polyacrylates, or else a mixture (blend) of these. The other component is preferably polystyrene. Addition of the abovementioned other component(s) advantageously permits, as a function of the respective component(s), adjustment of the mechanical properties and structure of the inventive foamable copolymers, and of their level of hydrophilic properties, as a function of the requirement placed upon the resultant foam.

The other components here are mixed with the inventive foamable copolymers, and their amounts comprised are preferably in the range of from 1 to 99% by weight, particularly preferably in the range from 10 bis 70% by weight, based in each case on the weight of the composition.

The density of the foams obtained via foaming of the inventive foamable copolymers is in the range from 40 to 300 g/l, preferably in the range from 50 to 200 g/l. The average foam cell size is in the range from 50 to 500 μm, preferably in the range from 100 to 200 μm.

The following examples and figures are intended to illustrate the invention.

FIG. 1 shows: the scanning electron micrograph of a foam composed of an itaconic acid/acrylic acid copolymer (1:3 [% by weight]), crosslinked with 30% by weight of TEA in the presence of 1% by weight of talc.

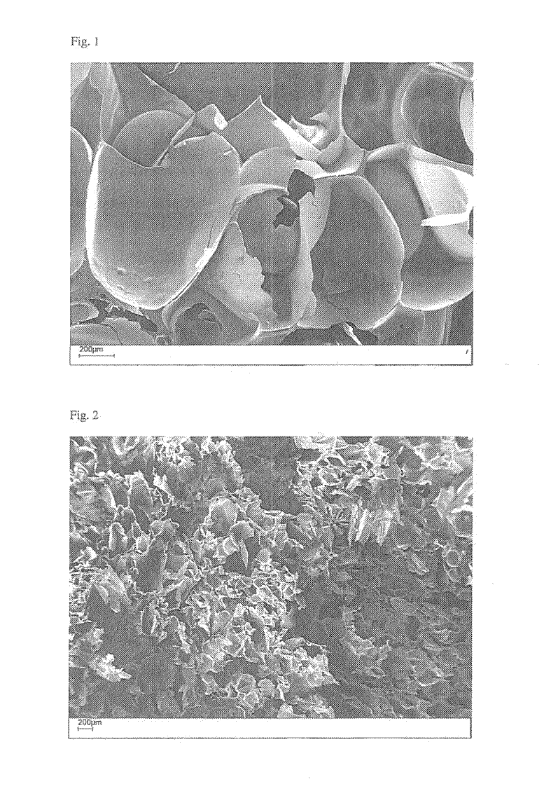

FIG. 2 shows: the scanning electron micrograph of a foam composed of an itaconic acid/acrylic acid copolymer (1:3 [% by weight]), crosslinked with 30% by weight of THEED in the presence of 1% by weight of talc.

FIG. 3 shows: the scanning electron micrograph of a foam composed of an itaconic acid/acrylic acid copolymer (1:3 [% by weight]), crosslinked with 30% by weight of TRIPA in the presence of 1% by weight of talc.

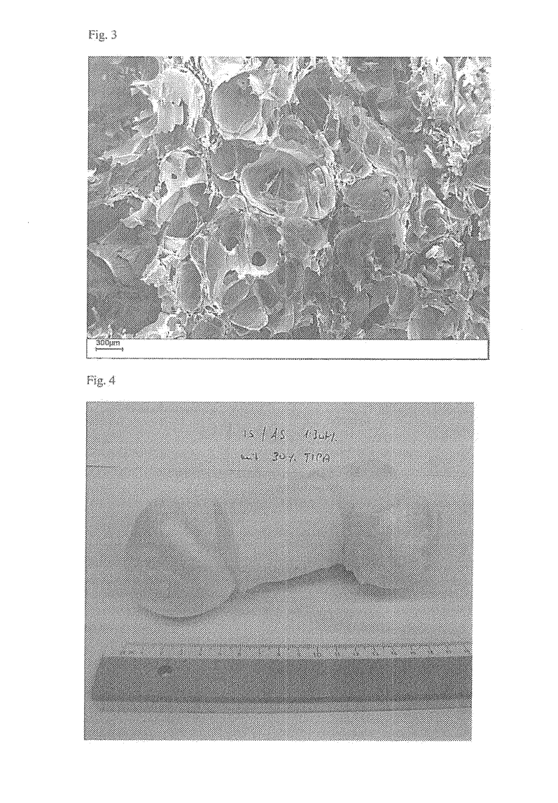

FIG. 4 shows: the image recorded from a foam composed of an itaconic acid/acrylic acid copolymer (1:3 [% by weight]), crosslinked with 30% by weight of TRIPA in the presence of 1% by weight of talc.

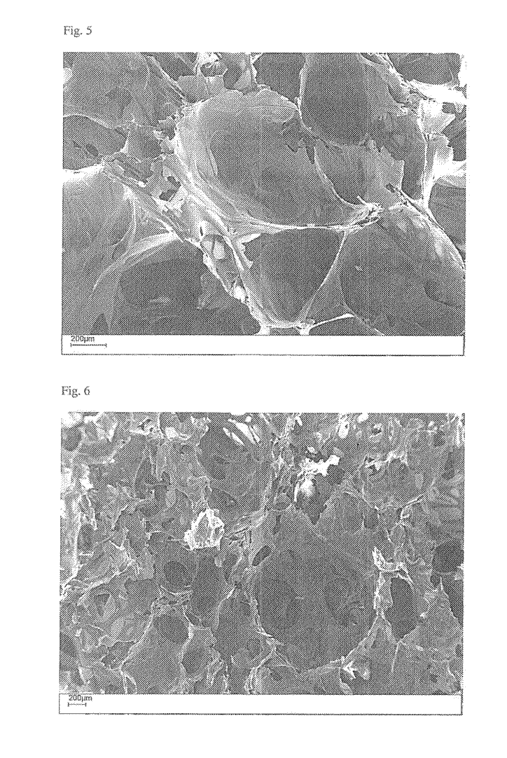

FIG. 5 shows: the scanning electron micrograph of, a foam which is composed of 90% by weight of a foamable copolymer composed of an itaconic acid/acrylic acid copolymer (1:3 [% by weight]), crosslinked with 30% by weight of TRIPA in the presence of 1% by weight of talc, and 10% by weight of polystyrene.

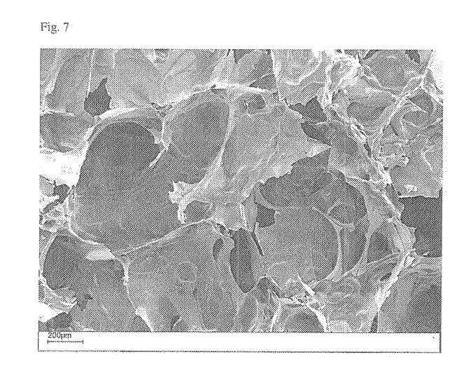

FIG. 6 shows: the image recorded from a foam which is composed of 90% by weight of a foamable copolymer composed of an itaconic acid/acrylic acid copolymer (1:3 [% by weight]), crosslinked with 30% by weight of TRIPA in the presence of 1% by weight of talc, and 30% by weight of polystyrene.

FIG. 7 shows: the scanning electron micrograph of a foam which is composed of 90% by weight of a foamable copolymer composed of an itaconic acid/acrylic acid copolymer (1:3 [% by weight]), crosslinked with 30% by weight of TRIPA in the presence of 1% by weight of talc, and 50% by weight of polystyrene.

### A ANALYSIS

### a) Determination of K Value

The K values for the aqueous solutions of the copolymers were determined by the method of H. Fikentscher, Cellulose-Chemie, volume 13, 48 to 64 and 71 to 74 (1932) in aqueous solution at pH 7, temperature 25° C. and copolymer concentration of 1% in deionized water.

### B PRODUCTION OF THE COPOLYMERS VIA FREE-RADICAL COPOLYMERIZATION OF ONE OR MORE MONOETHYLENICALLY UNSATURATED MONOMERIC COMPOUNDS WITH ITACONIC ACID

### Example 1

### Copolymer Composed of Acrylic Acid/Itaconic Acid

70 g of itaconic acid are dissolved in 575 g of deionized water and heated to gentle reflux at a temperature of 98° C. in a stirred vessel with blade stirrer. Feed 1, composed of 210 g of acrylic acid in 380 g of deionized water, is then added over a period of 5 hours and feed 2, composed of 4.2 g of sodium peroxodisulfate (NaPS) in 124 g of deionized water, is then added over a period of 6 hours, to the initial charge. After completion of the addition by way of feed 1, the mixture is stirred at 98° C. for a further 2 hours. This gives a pale yellow, clear polymer solution whose solids content is 25.7 g and whose K value (1% strength in deionized water) is 35.4.

### Example 2

### Copolymers Composed of Acrylic Acid/Itaconic Acid-Acrylic Acid Metering by Way of a Ramp

The syntheses were carried out in an A 100-3 ChemSpeed system in reactors respectively of 100 ml capacity.

The parameters for the syntheses are shown in Tables 1 and 2. The reaction times were from 6 to 8 hours. Initiator concentration was in the region of 150% and 200%, when comparison is made with the above Example 1. The initiator was added over a period of 30 minutes to the initial charge of itaconic acid, and then the acrylic acid was metered in by way of a ramp. The parameters for the ramps are shown in Table 2.

This gives a pale yellow, clear polymer solution whose weight-average molecular weight is from 38 000 to 175 000 daltons.

TABLE 1
Batches

| | Reactor 1 | | Reactor 2 | | Reactor 3 | | Reactor 4 | | Reactor 5 | | Reactor 6 | | Reactor 7 | | Reactor 8 | |
|---|---|---|---|---|---|---|---|---|---|---|---|---|---|---|---|---|
| Acrylic acid | 35.59 | ml | 35.59 | ml | 35.59 | ml | 35.59 | ml | 35.59 | ml | 35.59 | ml | 35.59 | ml | 35.59 | ml |
| (70%) | | | | | | | | | | | | | | | | |
| Itaconic acid | 20.86 | ml | 20.86 | ml | 20.86 | ml | 20.86 | ml | 20.86 | ml | 20.86 | ml | 20.86 | ml | 20.86 | ml |
| (30%) | | | | | | | | | | | | | | | | |
| NaPS | 6.68 | ml | 6.68 | ml | 6.68 | ml | 6.68 | ml | 8.9 | ml | 8.9 | ml | 8.9 | ml | 8.9 | ml |

| | | | | | | | |
|---|---|---|---|---|---|---|---|
| (150%) | (150%) | (150%) | (150%) | (200%) | (200%) | (200%) | (200%) |

| | | | | | | | | | | | | | | | | |
|---|---|---|---|---|---|---|---|---|---|---|---|---|---|---|---|---|
| Temperature | 99° | C. | 99° | C. | 99° | C. | 99° | C. | 99° | C. | 99° | C. | 99° | C. | 99° | C. |
| Reaction time | 6 | h | 6 | h | 6 | h | 6 | h | 6 | h | 6 | h | 6 | h | 6 | h |

| | | | | | | | | |
|---|---|---|---|---|---|---|---|---|
| Ramp | 100%-0% | 90%-10% | 80%-20% | 60%-40% | 100%-0% | 90%-10% | 80%-20% | 60%-40% |

Batches

| | Reactor 9 | | Reactor 10 | | Reactor 11 | | Reactor 12 | | Reactor 13 | | Reactor 14 | | Reactor 15 | | Reactor 16 | |
|---|---|---|---|---|---|---|---|---|---|---|---|---|---|---|---|---|
| Acrylic acid | 35.59 | ml | 35.59 | ml | 35.59 | ml | 35.59 | ml | 35.59 | ml | 35.59 | ml | 35.59 | ml | 35.59 | ml |
| (70%) | | | | | | | | | | | | | | | | |
| Itaconic acid | 20.86 | ml | 20.86 | ml | 20.86 | ml | 20.86 | ml | 20.86 | ml | 20.86 | ml | 20.86 | ml | 20.86 | ml |
| (30%) | | | | | | | | | | | | | | | | |
| NaPS | 6.68 | ml | 6.68 | ml | 6.68 | ml | 6.68 | ml | 8.9 | ml | 8.9 | ml | 8.9 | ml | 8.9 | ml |
| | (150%) | | (150%) | | (150%) | | (150%) | | (200%) | | (200%) | | (200%) | | (200%) | |
| Temperature | 99° | C. | 99° | C. | 99° | C. | 99 | ° C. | 99° | C. | 99° | C. | 99° | C. | 99° | C. |
| Reaction time | 8 | h | 8 | h | 8 | h | 8 | h | 8 | h | 8 | h | 8 | h | 8 | h |

| | | | | | | | | |
|---|---|---|---|---|---|---|---|---|
| Ramp | 100%-0% | 90%-10% | 80%-20% | 60%-40% | 100%-0% | 90%-10% | 80%-20% | 60%-40% |

TABLE 2
Acrylic acid addition by way of ramp 35.59 ml

| Base level | 1 | 2 | 3 | 4 | 5 | 6 | 7 | 8 | Total |
|---|---|---|---|---|---|---|---|---|---|
| Reactor 1 | 8.898 | 7.626 | 6.355 | 5.084 | 3.813 | 2.542 | 1.271 | 0.000 | 35.590 |
| Reactor 2 | 8.008 | 6.991 | 5.974 | 4.957 | 3.940 | 2.923 | 1.907 | 0.890 | 35.590 |
| Reactor 3 | 7.118 | 6.355 | 5.593 | 4.830 | 4.067 | 3.305 | 2.542 | 1.780 | 35.590 |
| Reactor 4 | 5.339 | 5.084 | 4.830 | 4.576 | 4.322 | 4.067 | 3.813 | 3.559 | 35.590 |
| Reactor 5 | 8.898 | 7.626 | 6.355 | 5.084 | 3.813 | 2.542 | 1.271 | 0.000 | 35.590 |
| Reactor 6 | 8.008 | 6.991 | 5.974 | 4.957 | 3.940 | 2.923 | 1.907 | 0.890 | 35.590 |
| Reactor 7 | 7.118 | 6.355 | 5.593 | 4.830 | 4.067 | 3.305 | 2.542 | 1.780 | 35.590 |
| Reactor 8 | 5.339 | 5.084 | 4.830 | 4.576 | 4.322 | 4.067 | 3.813 | 3.559 | 35.590 |

| Base level | 1 | 2 | 3 | 4 | 5 | 6 | 7 | 8 | 9 | 10 | Total |
|---|---|---|---|---|---|---|---|---|---|---|---|
| Reactor 9 | 7.118 | 6.327 | 5.536 | 4.745 | 3.954 | 3.164 | 2.373 | 1.582 | 0.791 | 0.000 | 35.590 |
| Reactor 10 | 6.406 | 5.773 | 5.141 | 4.508 | 3.875 | 3.243 | 2.610 | 1.977 | 1.345 | 0.712 | 35.590 |
| Reactor 11 | 5.694 | 5.220 | 4.745 | 4.271 | 3.796 | 3.322 | 2.847 | 2.372 | 1.898 | 1.424 | 35.590 |
| Reactor 12 | 4.271 | 4.113 | 3.954 | 3.796 | 3.638 | 3.480 | 3.322 | 3.164 | 3.005 | 2.847 | 35.590 |
| Reactor 13 | 7.118 | 6.327 | 5.536 | 4.745 | 3.954 | 3.164 | 2.373 | 1.582 | 0.791 | 0.000 | 35.590 |
| Reactor 14 | 6.406 | 5.773 | 5.141 | 4.508 | 3.875 | 3.243 | 2.610 | 1.977 | 1.345 | 0.712 | 35.590 |
| Reactor 15 | 5.694 | 5.220 | 4.745 | 4.271 | 3.796 | 3.322 | 2.847 | 2.372 | 1.898 | 1.424 | 35.590 |
| Reactor 16 | 4.271 | 4.113 | 3.954 | 3.796 | 3.638 | 3.480 | 3.322 | 3.164 | 3.005 | 2.847 | 35.590 |

### C1 Production of the Inventive Foamable Copolymers and of the Foams

### Example 1

A crosslinking agent is added to a copolymer composed of itaconic acid (molecular weight >200 000). Deionized water and 1% by weight of nucleating agent are admixed with the mixture and stirred. The entire solution is vigorously mixed over a period of 1 hour using a magnetic stirrer. A colorless powder is obtained by freeze- or spray-drying. The powder is weighed into a mold and foamed for at least 30 minutes at 140° C. The copolymers used are given in Table 3.

TABLE 3

| Copolymer | ratio (% by weight) |
|---|---|
| IA/AA | 1:1.1 |
| | 1:1.67 |
| | 1:2.7 |
| | 1:3 |
| | 1:08 |
| IA/styrene | 1:1.20 |
| IA/AA/styrene | 51/28/21 |

IA = itaconic acid;
AA = acrylic acid

The copolymers stated in Table 4 are used as crosslinking agents:

TABLE 4

| | Proportion |
|---|---|
| Crosslinking Agent | (% by weight) |
| Triethanolamine | 30 |
| | 40 |
| | 50 |
| | 60 |
| N,N,N,N-tetrakis(2-hydroxyethynol)ethylenediamine | 30 |
| | 51 |
| N,N,N-tetrakis(2-hydroxyethyl)adipamide | 30 |
| Helizarin | 30 |
| Triisopropanolamine | 30 |
| | 44.4 |

Nucleating agents used comprised talc (magnesium silicate), magnesium carbonate, calcium carbonate, huntite/hydromagnesite, KMgAl silicates, in a proportion of 1% by weight based on the total weight of the polymer.

The foams exhibited a closed-cell structure whose density was in the range of from 50 to 200 g/l.

### C2

A crosslinking agent is added to a copolymer composed of itaconic acid (molecular weight >200 000). Deionized water and 1% by weight of nucleating agent are admixed with the mixture and stirred. The entire solution is vigorously mixed over a period of 1 hour using a magnetic stirrer. A colorless powder is obtained by freeze- or spray-drying. The powder is blended with 10% by weight, 30% by weight and, respectively 50% by weight of polystyrene or starch, weighed into a mold, and foamed at 140° C. for a period of at least 30 minutes.

FIGS. 5 to 7 show electron micrographs of foams produced from blends of the inventive foamable copolymers and styrene. During production of the foams, inventive foamable copolymers were blended with 10% by weight (FIG. 5), 30% by weight (FIG. 6) and 50% by weight (FIG. 7) of polystyrene and then foamed. The foams exhibit an open-cell structure whose density is 122 g/l, 280 g/l and, respectively, 270 g/l.

Images from some of the foams of the examples are shown in FIGS. 1 to 7.

The foam shown in FIG. 1 (itaconic acid/acrylic acid (1:3 [% by weight]), TEA (30% by weight), talc (1% by weight)) exhibits a closed-cell structure whose density is 109 g/l. The size of the cells varies from 50 to 400 μm.

The foam shown in FIG. 2 (itaconic acid/acrylic acid (1:3 [% by weight]), THEED (30% by weight), talc (1% by weight)) exhibits a closed-cell structure whose density is 130 g/l. The size of the cells varies from 100 to 400 μm.

The foam shown in FIG. 3 (itaconic acid/acrylic acid (1:3 [% by weight]), TRIPA (30% by weight), talc (1% by weight)) exhibits a open-cell structure whose density is from 100 to 200 g/l.

FIG. 4 shows a photograph of the foam shown in FIG. 3.

1-13. (canceled)

14. A process for the production of foamable copolymers, comprising the steps of:
(i) preparation of at least one reaction mixture (a) via free-radical copolymerization of one or more monoethylenically unsaturated monomeric compound(s) (monomer(s) A1) with one or more compound(s) selected from the group of itaconic acid, mesaconic acid, fumaric acid, maleic acid, aconitic acid, glutaconic acid and their salts, esters and anhydrides (monomer(s) A2), and
(ii) reaction of at least one of the copolymers obtained in step (i) with one or more crosslinking agent(s) (b).

15. The process according to claim 14, where the monoethylenically unsaturated compound(s) (monomer(s) A1) has/have been selected from the group of styrene, α-methylstyrene, o-chlorostyrene, vinyl chloride, vinylidene chloride, vinyl acetate, methyl (meth)acrylate, vinyl propionate, vinyl n-butyrate, vinyl laurate, vinyl stearate, itaconic acid, acrylonitrile, methacrylonitrile, fumaronitrile, maleonitrile, 1,3-butadiene (butadiene), isoprene, acrylamide, methacrylamide, vinylsulfonic acid, acrylic acid, methacrylic acid, maleic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearylic acid, citraconic acid, aconitic acid, fumaric acid, tricarboxyethylene anhydride and maleic anhydride.

16. The process according to claim 14, where the one or more crosslinking agents (b) has/have been selected from the group of polyols, polyethylene glycol, propylene glycol, polypropylene glycol, 1,3-butanediol, 1,4-butanediol, 1,5-pentanediol, 2,4-pentanediol, 1,6-hexanediol, 2,5-hexanediol, glycerol, polyglycerol, trimethylolpropane, polyoxypropylene, oxyethylene-oxypropylene block copolymers, sorbitan fatty acid esters, polyoxyethylenesorbitan fatty acid esters, pentaerythritol, polyvinyl alcohol, and sorbitol, aminoalcohols, polyamine compounds, N,N,N,N-tetrakis(2-hydroxyethyl)ethylenediamine (THEED), N,N,N,N-tetrakis(2-hydroxyethyl)adipamide (THEAA), triisopropanolamine (TRIPA), polyglycidic ether compounds, polyisocyanates, polyaziridine compounds, halogen peroxides, alkylene carbonates, and polyquaternary amines.

17. The process according to claim 14, where, in process step (i), the amount used of the monomers A1 is from 50 to 99% by weight and the amount used of the monomers A2 is from 1 to 50% by weight.

18. The process according to claim 14, where the ratio by weight of reaction mixture (a) to crosslinking agent (b) is from 1:10 to 100:1.

19. The process according to claim 14, where a nucleating agent is used during the reaction of the reaction mixture (a) with the one or more crosslinking agents (b).

20. The process according to claim 19, where talc is used as nucleating agent.

21. The process according to claim 14, where, in step (ii), at least one copolymer from step (i) whose number-average molar mass is from 15 000 to 1 000 000 g/mol is used.

22. The process according to claim 14, where the foamable copolymers are foamed in a further process step.

23. The process according to claim 22, where the foamable copolymers are foamed at a temperature of from 50 to 300° C.

24. The process according to claim 22, where the foamable copolymers are foamed with exposure to microwave radiation.

25. A foamable copolymer that can be produced by the process according to claim 14.

26. A polymer foam whose density is from 40 to 200 g/l, that can be prepared according to claim 21.

27. The process according to claim 16, where the polyol is ethylene glycol.

28. The process according to claim 16, where the polyethylene glycol is selected from the group consisting of diethylene glycol, triethylene glycol and tetraethylene glycol.

28. The process according to claim 16, where the aminoalcohol is selected from the group consisting of ethanolamine, diethanolamine, triethanolamine, and propanolamine.

29. The process according to claim 16, where the polyamine compound is selected from the group consisting of ethylenediamine, diethylenetetramine, triethylenetetramine, tetraethylenepentamine and pentaethylenehexamine.

30. The process according to claim 16, where the polyglycidic ether compounds is selected from the group consisting of ethylene glycol diglycidyl ether, polyethylene glycol diglycidyl ether, glycerol polyglycidyl ether, pentaerythritol polyglycidyl ether, propylene glycol diglycidyl ether, polypropylene glycol diglycidyl ether, neopentyl glycol diglycidyl ether, hexanediol glycidyl ether, trimethylolpropanol glycidyl ether, sorbitol polyglycidyl ether, phthalic acid diglycidyl ether, adipic acid diglycidyl ether, and glycidol.

31. The process according to claim 16, where the polysiscyanate is selected from the group consisting of toluene 2,4-diisocyanate and hexamethylene diisocyanate.

32. The process according to claim 16, where the polyaziridine compounds is selected from the group consisting of 2,2-bishydroxymethylbutanol tris[3-(1-aziridinyl)propionate], 1,6-hexamethylenediethyleneurea, and diphenylmethanebis-4,4′-N,N1-diethyleneurea.

33. The process according to claim 16, where the halogen peroxide is selected from the group consisting of epichlorohydrin, epibromohydrin, and a-methylepichlorohydrin.
